(19) United States
(12) Patent Application Publication
(10) Pub. No.: US 2017/0020769 A1
(43) Pub. Date: Jan. 26, 2017

(54) CUSHION SUPPORT INSERT

(71) Applicant: PRS Medical Technologies, Inc., Atherton, CA (US)

(72) Inventors: Nikhil BHAT, Fremont, CA (US); George Y. CHOI, Atherton, CA (US); Robert A. BROMMER, Fremont, CA (US)

(73) Assignee: PRS Medical Technologies, Inc., Atherton, CA (US)

(21) Appl. No.: 15/207,222

(22) Filed: Jul. 11, 2016

Related U.S. Application Data
(60) Provisional application No. 62/194,573, filed on Jul. 20, 2015.

(51) Int. Cl. A61H 9/00; A47C 27/18; A47C 7/02; A61H 23/00

(52) U.S. Cl. CPC A61H 9/0078; A61H 23/00; A47C 27/18; A47C 7/021; A47C 7/022; A61H 2201/5071; A61H 2205/086; A61H 2201/0207

(57) ABSTRACT

A cushion support insert is described generally having a cushion with a surface sized for placement beneath a body of a user, the surface defining at least a first channel and a second channel therein. A fluid-filled bladder may be sized for placement upon the surface and a first plurality of pods and a second plurality of pods may be positioned upon or beneath opposing ends of the fluid-filled bladder such that the first plurality and second plurality are retained respectively within the first channel and the second channel. Each of the pods may be fluid-filled and aligned adjacent to one another within a respective first covering and second covering.

### CROSS-REFERENCE TO RELATED APPLICATIONS

This application claims the benefit of priority to U.S. Prov. App. 62/194,573 filed Jul. 20, 2015, which is incorporated herein by reference in its entirety.

### FIELD OF THE INVENTION

The present invention relates to devices and methods for supporting a user sitting upon a surface. More particularly, the present invention relates to devices and methods for supporting a user via a support utilizing individual cushioning pods in combination with a fluid filled pad incorporated into a platform such as a cushion for increasing user comfort as well as preventing and treating conditions such as pressure ulcers.

### BACKGROUND OF THE INVENTION

Individuals who are forced to sit or lie down for extended periods of time typically experience tissue necrosis over localized regions of their body known as decubitus ulcers or pressure sores. In 2009 more than a million people in acute care centers were affected with pressure ulcers. In addition to acute care centers, more than 500,000 people in long-term care centers are diagnosed with pressure ulcers every year. Pressure ulcers generally occur at locations of the body where the bony prominence is high and the underlying skin breaks down when constant pressure is placed against the skin. Blood circulation is inhibited or prevented in these localized areas and can even occur when the patient has been lying against or upon cushioning devices. Examples of areas of the body where pressure sores typically occur include the sacrum, greater trochanter, ischial tuberosity, malleolus, heel, etc. When pressure ulcers form, they can lead to extensive stays in the hospital or even to amputation.

Conventional cushioning devices generally utilize flexible materials such as foam or springs which allow for the cushion to deform and conform to the patient's body. While the cushioning device attempts to redistribute the loading from localized regions of the patient's body to a larger area over the rest of the body, such devices typically bottom out such that the patient's body contacts the underlying platform and nonetheless localizes the pressure onto the body.

Other cushioning devices have utilized fluid-filled cushions which consist of large single bladders or compartmentalized fluid or gas-filled bladders which inhibit fluid contained within the bladders from flowing laterally. In a fluid filled bladder disposed on a contoured seat, the fluid filled bladder typically bottoms out in one or more areas when supporting a patient's body weight. The places where the bladder bottoms out are sources of high localized pressure. Thus, such an assembly does not distribute pressure evenly across the portions of the anatomy in contact with the bladder. The amount of water that is used in such a bladder can be increased such that bottoming out does not occur. However, this design sacrifices stability. Additionally, since such cushions are typically designed to accommodate a wide range of patient populations, patients who are not as heavy as the maximum for which the cushion was designed for will suffer even more lack of stability than would be needed.

Another problem with simply increasing the amount of fluid to prevent bottoming out is that this requires significant volume of fluid beneath the patient and/or require specialized bedding. Additionally, many fluid filled membranes are too thick to provide adequate pressure relief because the hammocking that occurs in the regions of high protrusions. Thus, the suspension of the patient's body typically results in significantly non-uniform pressure application, with higher pressures being applied to protruding portions of the patient's body due to lack of adequate conformance of the bladder material to the patient's body.

Yet other cushioning devices utilize segmented bladders in an attempt to isolate individual bladders from one another. Yet such segmented cushions may fail to allow for the cushion to fully conform to the patient's body as fluid flow between each of the segmented cushions is prevented.

Accordingly, there exists a need for a cushioning device which may conform to regions of the patient's body to increase comfort as well as prevent decubitis ulcers in a manner which is more cost efficient, convenient, and effective.

### BRIEF SUMMARY OF THE INVENTION

A support assembly as described herein may be incorporated into or upon a cushion that the user sits upon when such cushions are used in comfort chairs such as recliners, massage chairs, office chairs, sofas, car seats, or any other sitting or sleeping surface or platform to provide a cushioning surface which distributes the pressure of a user around the user's body.

Generally, one variation of the support assembly may comprise a cushion having a surface sized for placement beneath a body of a user, the surface defining at least a first channel and a second channel therein and a fluid-filled bladder sized for placement upon the surface. The assembly may further comprise a first plurality of pods which are fluid-filled and aligned adjacent to one another within a first covering such that each pod within the first covering is in contact with an adjacent pod and a second plurality of pods which are fluid-filled and aligned adjacent to one another within a second covering such that each pod within the second covering is in contact with an adjacent pod. The first plurality of pods and the second plurality of pods are positioned upon or beneath opposing ends of the fluid-filled bladder such that the first plurality and second plurality are retained respectively within the first channel and the second channel.

In another variation, the cushion may have a surface sized for placement beneath a body of a user, the surface defining at least a first channel and a second channel and a depression extending between the channels. The fluid-filled bladder may be sized for placement upon the depression and the first and second channels.

One variation of a support assembly may use a cushion which defines a receiving channel at least partially within the material of the cushion for receiving an insert assembly. The receiving channel and insert assembly may be positioned in proximity to where the user would typically sit upon the surface of cushion when properly seated upon the chair or surface.

The cushion itself may have first and second channels defined along the cushion with a depression defined between the channels which may be spaced apart from one another such that the channels are aligned in proximity to where the outer thighs of the user would typically be placed when seated upon the cushion. The channels may also be defined at a depth from an upper surface of the cushion although this depth may be varied between both channels or just a single channel. Additionally, the channels may be defined to be parallel to one another although in other variations, the channels may be angled relative to one another. A depression may be defined to extend between the channels at a depth relative to the upper surface of the cushion. While the depth of depression may be relatively shallower than the depth of the channels, in other variations the depth may be the same or similar to one another.

In either case, the insert assembly may generally comprise a fluid bladder which is sized to accommodate the user sitting upon the bladder. The bladder may be filled with any number of incompressible fluids, e.g., water, oils, fluids of various viscosities, or combinations thereof. Additionally and/or alternatively, the fluid bladder may be defined as a single or multiple chambered layer.

The insert assembly may also comprise a number of fluid-filled pods which are contained in alignment in at least two pod support assemblies which are contained within coverings. The pod assemblies and bladder may be contained within a cover and positioned over the cushion such that the fluid bladder may be positioned within the bottom portion of the first channel, over depression, and also within the bottom portion of the second channel such that the pods are aligned within the channels while resting upon the upper surface of the bladder. The cushion cover may then encapsulate the entire assembly. With the fluid bladder and pods positioned accordingly within or upon the cushion, the insert assembly may maintain a flush low-profile over the cushion but still ensure that the fluid contained within the fluid bladder and pods provides the support to the user. In other variations, the channels and depression may be omitted entirely and the insert assembly may be positioned directly atop the cushion surface. In yet other variations, the pod assemblies enclosed within their respective coverings may be positioned directly between the bottom of the first and second channels and the bottom surface of the fluid bladder.

With any of the variations described herein, different features and aspects from each of the variations may be combined with one another in various combinations.

### BRIEF DESCRIPTION OF THE DRAWINGS

FIG. 1A shows a perspective view of a cushion support having a support assembly incorporated into the cushion.

FIG. 1B shows an exploded assembly view of the cushion support and support assembly of FIG. 1A.

FIG. 1C shows a cross-sectional end view of the support assembly positioned upon the cushion support.

FIG. 1D shows a perspective view of the pod assembly contained within a pod support covering.

FIG. 2A shows a perspective view of a cushion support having another variation of a support assembly incorporated into the cushion.

FIG. 2B shows an exploded assembly view of the cushion support and support assembly of FIG. 2A.

FIG. 2C shows a cross-sectional end view of the support assembly positioned upon the cushion support.

FIG. 3A shows a perspective view of an insert assembly and cushion support also incorporating a temperature pad or layer.

FIG. 3B shows a perspective view of another insert assembly and cushion support incorporating a vibration actuator for imparting a massaging action.

FIG. 3C shows a perspective view of yet another insert assembly and cushion support incorporating both a temperature pad or layer and a vibration actuator.

### DETAILED DESCRIPTION OF THE INVENTION

A typical cushion support such as those found in comfort chairs are generally made of a foam material and offer some support to the user sitting upon the cushion. These foam cushions typically provide a sitting or sleeping surface made of foam padding surrounded by a covering. However, foam materials by their nature compress and generate higher pressures against the user sitting upon the cushion. Thus, a support assembly as described herein may be incorporated into or upon a cushion that the user sits upon when such cushions are used in comfort chairs such as recliners, massage chairs, office chairs, sofas, car seats, or any other sitting or sleeping surface or platform to provide a cushioning surface which distributes the pressure of a user around the user's body.

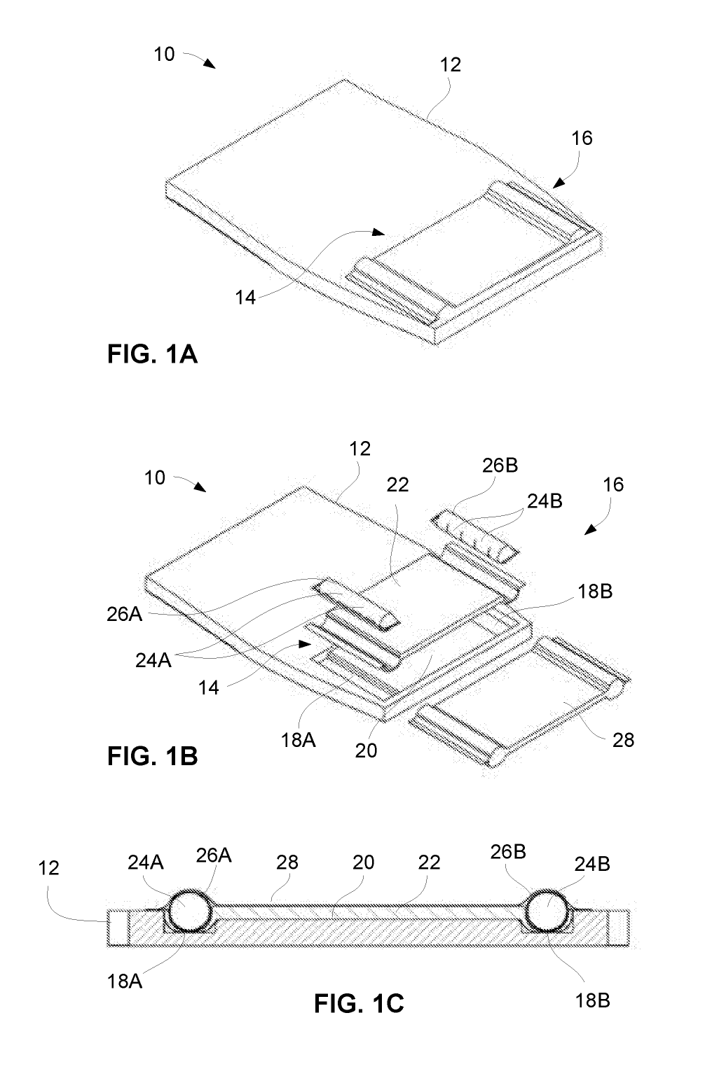

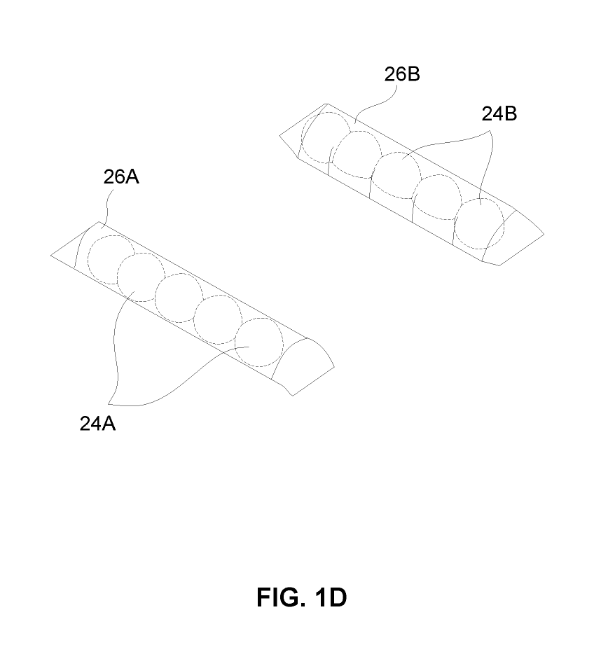

One variation of a support assembly 10 is shown in the perspective view of FIG. 1A, which illustrates a cushion 12 (e.g., open cell or closed cell foam, etc.) with the covering removed for clarity. The cushion 12 may define a receiving channel 14 at least partially within the material of the cushion 12 for receiving an insert assembly 16. The receiving channel 14 and insert assembly 16 may be positioned in proximity to where the user would typically sit upon the surface of cushion 12 when properly seated upon the chair or surface.

FIG. 1B illustrates an exploded perspective view of the insert assembly 16. The cushion 12 itself may have first and second channels 18A, 18B defined along the cushion 12 with a depression 20 defined between the channels 18A, 18B. The channels 18A, 18B may be spaced apart from one another such that the channels 18A, 18B are aligned in proximity to where the outer thighs of the user would typically be placed when seated upon the cushion 12, e.g., 10 to 100 cm apart. The channels 18A, 18B may also be defined at a depth of, e.g., 0.5 to 8 cm, from an upper surface of the cushion 12 although this depth may be varied between both channels or just a single channel. Additionally, the channels 18A, 18B may be defined to be parallel to one another although in other variations, the channels may be angled relative to one another. Depression 20 may be defined to extend between the channels 18A, 18B at a depth of, e.g., 0.1 to 5 cm, relative to the upper surface of the cushion 12, as shown in the cross-sectional end view of FIG. 1C. While the depth of depression 20 may be relatively shallower than the depth of the channels 18A, 18B, in other variations the depth may be the same or similar to one another.

In either case, the insert assembly 16 may generally comprise a fluid bladder 22 which is sized to accommodate the user sitting upon the bladder 22. For instance, the fluid bladder 22 may have a length of, e.g., 63.5 cm to 76.2 cm (25 in. to 30 in.), and a width of, e.g., 25.4 cm to 50.8 cm (10 in. to 20 in.). The bladder 22 may be filled with any number of incompressible fluids, e.g., water, oils, fluids of various viscosities, or combinations thereof. Additionally and/or alternatively, the fluid bladder 22 may be defined as a single or multiple chambered layer. In the event that the bladder 22 is comprised of multiple chambers, each of the chambers may be fluidly isolated or they may remain in fluid communication with one another. Optionally, the fluid bladder 22 may also contain one or more baffles throughout the interior to allow for a uniform flow of fluid through the interior volume.

The insert assembly 16 may also comprise a number of fluid-filled pods 24A, 24B which are contained in alignment in at least two pod support assemblies which are contained within coverings 26A, 26B. In this example, two support pod assemblies may be positioned along one or both sides of the bladder 22 such that pods 24A, 24B are aligned in series adjacent to one another upon an upper surface of the bladder 22 near or in proximity to opposing ends of the bladder 22. The pod assemblies and bladder 22 may be contained within a cover 28 and positioned over the cushion 12 such that the fluid bladder 22 may be positioned within the bottom portion of the first channel 18A, over depression 20, and also within the bottom portion of the second channel 18B, as shown in FIG. 1C, such that the pods 24A, 24B are aligned within the channels 18A, 18B while resting upon the upper surface of the bladder 22. The cushion cover may then encapsulate the entire assembly. With the fluid bladder 22 and pods 24A, 24B positioned accordingly within or upon the cushion 12, the insert assembly 16 may maintain a flush low-profile over the cushion 12 but still ensure that the fluid contained within the fluid bladder 22 and pods 24A, 24B provides the support to the user. In other variations, the channels 18A, 18B and depression 20 may be omitted entirely and the insert assembly 16 may be positioned directly atop the cushion 12 surface.

Further examples and details of other variations of the support assembly may be seen in the following patents and patent applications: U.S. Ser. Nos. 13/189,320 filed Jul. 22, 2011 (U.S. Pat. No. 8,776,798); 13/407,628 filed Feb. 28, 2012 (U.S. Pat. No. 8,656,919); 13/683,198 filed Nov. 21, 2012 (U.S. Pub. 2013/0112213 A1); 13/693,691 filed Dec. 4, 2012 (U.S. Pub. 2013/0092175 A1); 13/760,482 filed Feb. 6, 2013 (U.S. Pub. 2013/0180530 A1); 13/784,035 filed Mar. 4, 2013 (U.S. Pub. 2013/0180531 A1); 13/784,133 filed Mar. 4, 2013 (U.S. Pub. 2013/0174855 A1); 13/784,215 filed Mar. 4, 2013 (U.S. Pub. 2013/0174856 A1); 13/784,260 filed Mar. 4, 2013 (U.S. Pub. 2013/0174859 A1); and 13/945,684 filed Jul. 18, 2013 (U.S. Pub. 2013/0298918 A1). Each of these references is incorporated herein by reference in its entirety and for any purpose herein. It is also intended that the devices and methods described herein may be utilized with the features and methods described in these references in various combinations.

The fluid pad 22 may define a central portion which may provide support directly beneath the patient body by utilizing one or more fluid layers which are contained within and which helps to distribute any localized loads onto the surrounding areas and to further control their displacement and inhibit or prevent the bottoming out of the fluid layers. The pod assemblies may thus contain one or more fluid filled individual pods 24A, 24B which may be enclosed entirely within their respective coverings 26A, 26B. Each of the one or more pods 24A, 24B may be separated from one another such that no fluid communication occurs between the pods 24A, 24B and/or with the fluid bladder 22. Yet each of the pods 24A, 24B may occupy an envelope of, e.g., 1 cm×1 cm×0.5 cm to about 3 cm×3 cm×3 cm or even 35 cm×5 cm×5 cm, in an uncompressed state and they may be formed into various shapes, e.g., spherical, cylindrical, cubical, etc. Moreover, each of the pods may be formed from various materials such as polyurethane, silicone, vinyl, nylon, polyethylene vinyl acetate (PEVA), etc. having a thickness ranging from, e.g., 0.1 mm to 5 mm.

Although the FIG. 1D illustrates five pods contained within their respective covering, the number of pods used in each covering may range anywhere from, e.g., 1 to 30 or more (such as 2 to 100), arranged either uniformly or arbitrarily within the covering.

Additionally, while the pods 24A, 24B may be unconstrained within the covering 26A, 26B such that they freely move relative to one another, in other variations, the pods 24A, 24B may be secured within the covering 26A, 26B to one another itself such that their relative movement is constrained.

In either case, the pods 24A, 24B may transfer localized loads from the user received by a few pods 24A, 24B either to adjacent pods through the compression and transfer of pressure to adjacent contacting pods or through transmission via the fluid in the fluid bladder 22. The amount of compression of the pods 24A, 24B themselves may be controlled by the covering 26A, 26B which envelopes the pods 24A, 24B within. The covering 26A, 26B may function as a hammocking layer to constrain the amount of displacement experienced by the individual pods 24A, 24B and provide an increase in the net force constant relative to the force constant due to compression of the individual pods 24A, 24B. This increase in net force may be due to pressure applied by inner pad directly on the surfaces of the individual pods 24A, 24B and/or due to force applied through the fluid that fills the fluid bladder 22. The amount of compression experienced by the individual pods 24A, 24B may range anywhere from, e.g., 0% to 90% (or 10% to 90%), of the uncompressed height of the pods 24A, 24B. For example, for a pod 28 having an uncompressed height of 3 cm, the compression of the pod 24A, 24B may range anywhere from, e.g., 0 cm to 2.7 cm (or 0.3 cm to 2.7 cm).

Additionally and/or alternatively, any of the variations described herein may also incorporate the use of temperature modulation and control to further help prevent the formation of pressure ulcers. For example, the support assembly pad may be controlled to have a temperature which is lower than body temperature to help prevent the formation of pressure ulcers while having an assembly pad controlled to have a temperature which is higher than body temperature can be used to treat pressure ulcers which have already formed upon the body. For example, the assembly pad can be configured to control the contacted skin/tissue temperature to within ±10° C. of body temperature.

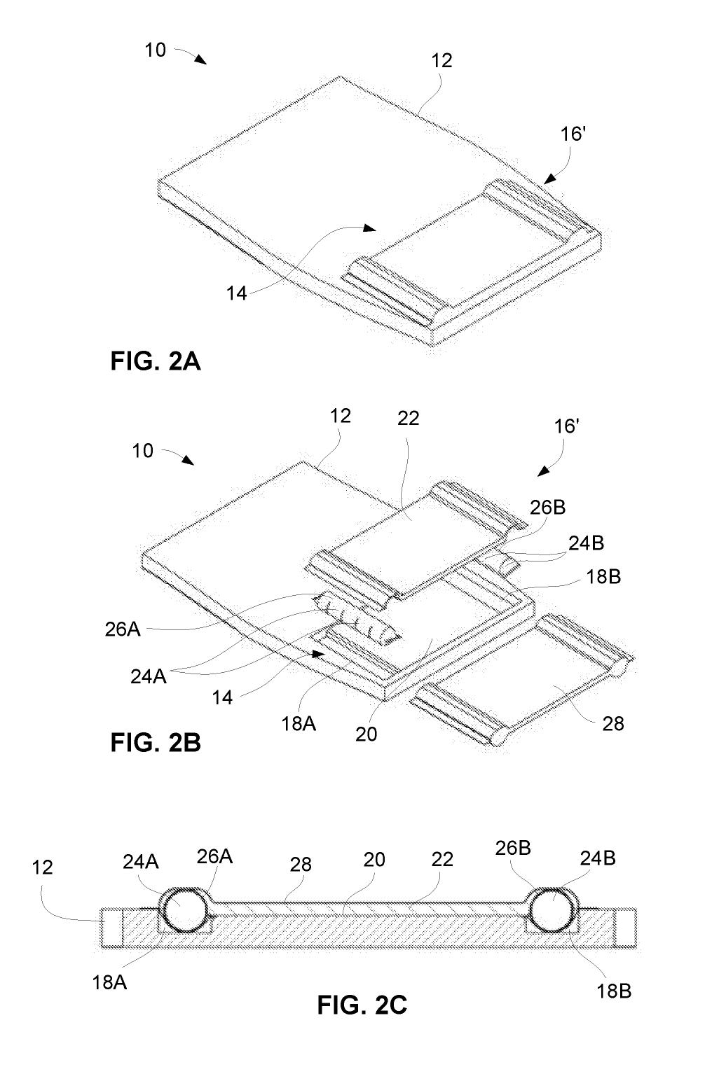

Another variation of the support assembly 10 is illustrated in the perspective view of FIG. 2A. This variation illustrates a cushion 12 and an insert assembly 16 configured similarly to the variation described above. Yet in this variation, the pod assemblies enclosed within their respective coverings 26A, 26B may be positioned directly between the bottom of the first and second channels 18A, 18B and the bottom surface of the fluid bladder 22, as shown in the perspective exploded view of FIG. 2B and cross-sectional end view of FIG. 2C.

Yet in other variations, one pod assembly may be positioned below the fluid bladder 22 while the other pod assembly is positioned above the fluid bladder. In yet another variation, the pod assemblies may be positioned within their respective first and second channels 18A, 18B, but the fluid bladder 22 may be sized to lay within the depression 20 without overlapping with the pods 24A, 24B positioned adjacent on either side of the fluid bladder 22.

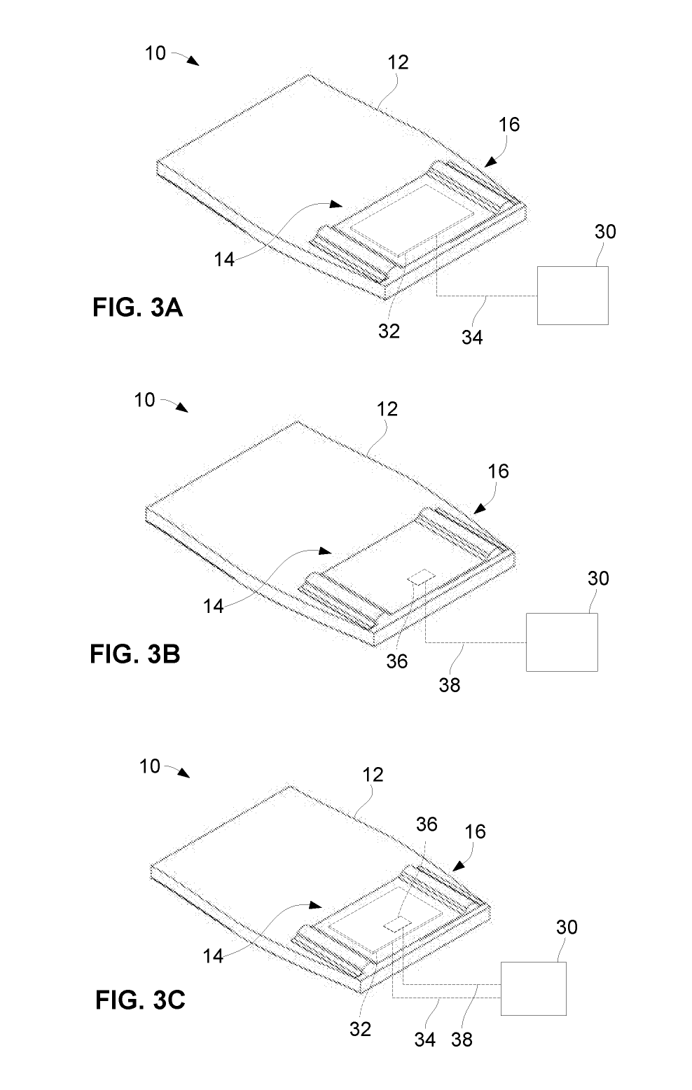

In yet another variation, FIG. 3A shows a perspective view of an insert assembly 16 and cushion support 12 also incorporating an optional temperature pad or layer 32 which may be heated and/or cooled (e.g., via resistive heating elements, Peltier junctions, etc.) to provide additional comfort to the user. The pad or layer 32 may be powered via a portable power supply or it may be powered by an external power supply and in either case, the pad or layer 32 may be in communication 34 (wired or wirelessly) with a controller 30 having a processor and/or memory components for controlling various functions of the pad or layer 32. For instance, the controller 30 may optionally control the temperature of the pad or layer 32 and the duration of time that the pad or layer 32 is activated. The controller 30 may also control various features such as the automated shutting on and/or shutting off of the pad or layer 32. In positioning the pad or layer 32 relative to the insert assembly 16, the pad or layer 32 may be incorporated directly into the insert assembly 16, directly into the cushion support 12, or it may be positioned between the insert assembly 16 and cushion support 12.

Another variation is illustrated in the perspective view of FIG. 3B which shows a vibration actuator 36 which may be optionally integrated into either the insert assembly 16 or cushion support 12 or positioned between the insert assembly 16 and cushion support 12. The vibration actuator 36 may be in communication 38 (wired or wirelessly) with the controller 30 which in this variation may be programmed to control various functions of the actuator 36, e.g., duration, start/stop times, vibrational intensity, etc., to provide a massaging effect to the user.

FIG. 3C shows yet another variation of an insert assembly 16 and cushion support 12 which optionally integrates both the temperature pad or layer 32 and vibration actuator 36, as described above. In this variation, the controller 30 may be programmed to control the various functions of both the pad or layer 32 and actuator 36 to provide temperature control as well as vibrational actuation either simultaneously, sequentially, and/or separately in any number of combinations.

The applications of the devices and methods discussed above are not limited to particular regions of the body but may include any number of further applications. Modification of the above-described device and methods for carrying out the invention, and variations of aspects of the invention that are obvious to those of skill in the art are intended to be within the scope of the claims.

What is claimed is:

1. A support assembly, comprising:
a cushion having a surface sized for placement beneath a body of a user, the surface defining at least a first channel and a second channel therein;
a fluid-filled bladder sized for placement upon the surface;
a first plurality of pods which are fluid-filled and aligned adjacent to one another within a first covering such that each pod within the first covering is in contact with an adjacent pod; and
a second plurality of pods which are fluid-filled and aligned adjacent to one another within a second covering such that each pod within the second covering is in contact with an adjacent pod,
wherein the first plurality of pods and the second plurality of pods are positioned upon or beneath opposing ends of the fluid-filled bladder such that the first plurality and second plurality are retained respectively within the first channel and the second channel.

2. The assembly of claim 1 wherein the cushion is comprised of a foam material.

3. The assembly of claim 1 wherein the cushion comprises a seat cushion.

4. The assembly of claim 1 wherein the first plurality of pods and second plurality of pods are securable to the fluid-filled bladder.

5. The assembly of claim 1 wherein the fluid-filled bladder comprises a bladder layer containing fluid within.

6. The assembly of claim 1 wherein movement of each pod is restrained by the respective first covering and second covering.

7. The assembly of claim 1 wherein each pod within the respective first plurality of pods and second plurality of pods is in communication with the adjacent pod such that a pressure is transferable between the pods

8. The assembly of claim 1 wherein the cushion further defines a depression between the first channel and second channel within which the fluid-filled bladder is positionable.

9. The assembly of claim 1 further comprising one or more pressure sensors positioned within or upon the assembly to sense pressure.

10. The assembly of claim 1 further comprising a temperature pad or layer for controlling a temperature of the assembly.

11. The assembly of claim 1 further comprising an vibrational actuator for providing a massaging effect.

12. The assembly of claim 1 further comprising a temperature pad or layer and a vibrational actuator.

13. A support assembly, comprising:
a cushion having a surface sized for placement beneath a body of a user, the surface defining at least a first channel and a second channel and a depression extending between the channels;
a fluid-filled bladder sized for placement upon the depression and the first and second channels;
a first plurality of pods which are fluid-filled and aligned adjacent to one another within a first covering such that each pod within the first covering is in contact with an adjacent pod; and
a second plurality of pods which are fluid-filled and aligned adjacent to one another within a second covering such that each pod within the second covering is in contact with an adjacent pod,
wherein the first plurality of pods and the second plurality of pods are positioned upon or beneath opposing ends of the fluid-filled bladder such that the first plurality and second plurality are retained respectively within the first channel and the second channel.

14. The assembly of claim 13 wherein the cushion is comprised of a foam material.

15. The assembly of claim 13 wherein the cushion comprises a seat cushion.

16. The assembly of claim 13 wherein the first plurality of pods and second plurality of pods are securable to the fluid-filled bladder.

17. The assembly of claim 13 wherein the fluid-filled bladder comprises a bladder layer containing fluid within.

18. The assembly of claim 13 wherein movement of each pod is restrained by the respective first covering and second covering.

19. The assembly of claim 13 wherein each pod within the respective first plurality of pods and second plurality of pods is in communication with the adjacent pod such that a pressure is transferable between the pods

20. The assembly of claim 13 further comprising one or more pressure sensors positioned within or upon the assembly to sense pressure.

21. The assembly of claim 13 further comprising a cushion covering sized to retain the support assembly within.

22. The assembly of claim 13 further comprising a temperature pad or layer for controlling a temperature of the assembly.

23. The assembly of claim 13 further comprising an vibrational actuator for providing a massaging effect.

24. The assembly of claim 13 further comprising a temperature pad or layer and a vibrational actuator.
